(19) United States
(12) Patent Application Publication
(10) Pub. No.: US 2025/0149553 A1
(43) Pub. Date: May 8, 2025

(54) ANODE FOR ALL-SOLID-STATE BATTERY, MANUFACTURING METHOD THEREOF AND ALL-SOLID-STATE BATTERY INCLUDING THE ANODE

(71) Applicants: Hyundai Motor Company, Seoul (KR); Kia Corporation, Seoul (KR); Pukyong National University Industry-University Cooperation Foundation, Busan (KR)

(72) Inventors: Yoon Kwang Lee, Suwon-si (KR); Yun Sung Kim, Seoul (KR); Ga Hyeon Im, Hwaseong-si (KR); Kyu Joon Lee, Seoul (KR); Hong Seok Min, Yongin-si (KR); So Young Lee, Suwon-si (KR); Su Jong Chae, Busan (KR); Min Sung Ko, Busan (KR); Ji Sub Choi, Busan (KR); Seong Su Park, Changwon-si (KR)

(21) Appl. No.: 18/636,696

(22) Filed: Apr. 16, 2024

(30) Foreign Application Priority Data
Nov. 3, 2023 (KR) 10-2023-0150845

(51) Int. Cl. H01M 4/36; H01M 4/02; H01M 4/04; H01M 4/38; H01M 4/587

(52) U.S. Cl. CPC H01M 4/366; H01M 4/0404; H01M 4/0428; H01M 4/386; H01M 4/587; H01M 2004/021; H01M 2004/027

(57) ABSTRACT

An embodiment anode for an all-solid-state battery, the anode including an anode current collector and an anode active material layer disposed on the anode current collector and including an anode active material, the anode active material including a plate-type carbon material, wherein a length ratio (a/c) of a major axis (a) to a thickness (c) of the plate-type carbon material is 4 or more, and a coating layer coating a portion of a surface of the plate-type carbon material, wherein the coating layer includes a lithiophilic material.

### CROSS-REFERENCE TO RELATED APPLICATIONS

This application claims the benefit of Korean Patent Application No. 10-2023-0150845, filed on Nov. 3, 2023, which application is hereby incorporated herein by reference.

### TECHNICAL FIELD

The present disclosure relates to an anode for all-solid-state batteries, a manufacturing method thereof, and an all-solid-state battery including the anode.

### BACKGROUND

Lithium secondary batteries are widely used in small devices to large energy storage systems, and the secondary battery market is growing in earnest due to the explosive growth of the electric vehicle market. In order to use a lithium secondary battery as an output source for electric vehicles, the lithium secondary battery requires high energy density and good output characteristics and, particularly, places importance on securing stability.

Conventional lithium secondary batteries for electric vehicles have risk of fire and explosion due to a liquid electrolyte including a flammable organic solvent, and they have a low energy density because a battery management system (BMS) configured to safely drive the lithium secondary battery is applied to a battery pack or a battery module and thus a volume occupied by one cell is not small.

In order to solve the above problem, a next-generation all-solid-state battery is being developed. The all-solid-state battery uses a non-flammable solid electrolyte, eliminates the risk of fire and explosion so as to ensure safety, and may thus omit parts of the battery management system related to fire safety, and therefore, a battery having a high energy density may be developed.

Currently, research on development of a graphite-silicon composite to exhibit higher capacity than graphite (372 mAh/g) as an anode active material for all-solid-state batteries is being actively conducted. It is difficult to commercialize a general blending method due to cracks and delamination caused by great volume expansion of silicon (Si), and thus, a method of developing an anode active material having a high capacity, which is 2 to 3 times more than the theoretical capacity of graphite, by coating a graphite surface with silicon (Si) is drawing attention.

However, when a general spherical carbon material is coated with silicon (Si) so as to ensure a high capacity of 1,000 mAh/g or more, life characteristics of an all-solid-state battery including an acquired anode active material are deteriorated.

The above information disclosed in this background section is only for enhancement of understanding of the background of embodiments of the disclosure and therefore it may contain information that does not form the prior art that is already known to a person of ordinary skill in the art.

### SUMMARY

The present disclosure relates to an anode for all-solid-state batteries, a manufacturing method thereof, and an all-solid-state battery including the anode. In particular embodiments, the anode has improved life characteristics and discharge capacity characteristics through an anode active material including a plate-type carbon material configured such that the ratio of the major axis to the minor axis thereof is controlled to a designated numerical range and a coating layer formed on the surface of the plate-type carbon material.

Embodiments of the present disclosure can solve problems associated with the prior art, and an embodiment of the present disclosure reduces deterioration of life characteristics and volume expansivity of an all-solid-state battery by coating the surface of a plate-type carbon material rather than the conventional spherical carbon material as a base material with a lithiophilic material, such as silicon (Si).

One embodiment of the present disclosure provides an anode for all-solid-state batteries including an anode current collector and an anode active material layer located on the anode current collector and including an anode active material, wherein the anode active material includes a plate-type carbon material and a coating layer configured to coat at least a part of a surface of the plate-type carbon material, wherein a length ratio (a/c) of a major axis (a) to a thickness (c) of the plate-type carbon material is 4 or more, and wherein the coating layer includes a lithiophilic material.

In a preferred embodiment, the plate-type carbon material may include a material selected from the group consisting of natural graphite, artificial graphite, and a combination thereof.

In another preferred embodiment, the length ratio (a/c) of the major axis (a) to the thickness (c) of the plate-type carbon material may be 4.130 to 5.987.

In still another preferred embodiment, a length ratio (a/b) of the major axis (a) to a minor axis (b) of the plate-type carbon material may be 1.120 to 2.054.

In yet another preferred embodiment, an average orientation angle of the major axis (a) of the plate-type carbon material to a plane direction of the anode current collector may be 12° or less.

In still yet another preferred embodiment, the lithiophilic material may include a material selected from the group consisting of silicon (Si), silver (Ag), manganese (Mg), tin (Sn), bismuth (Bi), zinc (Zn), and combinations thereof. Preferably, the lithiophilic material may include amorphous silicon (Si).

In a further preferred embodiment, a thickness of the coating layer may be 20 nm to 200 nm.

In another further preferred embodiment, the anode active material may include 10 wt % to 60 wt % of the coating layer with respect to a total weight of the anode active material.

In still another further preferred embodiment, the anode active material layer may further include an inorganic electrolyte.

Another embodiment of the present disclosure provides an all-solid-state battery including the anode, a solid electrolyte layer located on the anode active material layer and including a solid electrolyte, a cathode active material layer located on the solid electrolyte layer and including a cathode active material, and a cathode current collector located on the cathode active material layer.

In a preferred embodiment, the all-solid-state battery may satisfy the Equation below.

### Equation:

(V₁₀₀−V₀)/V₀×100≤12%

Here, V₁₀₀ may be a volume of the anode active material layer in a fully discharged state of the all-solid-state battery after a charge and discharge cycle was performed 100 times, and V₀ may be a volume of the anode active material layer when charging and discharging of the all-solid-state battery is not performed.

Another embodiment of the present disclosure provides a manufacturing method of an anode for all-solid-state batteries, the method including preparing a plate-type carbon material and a precursor of a lithiophilic material, synthesizing an anode active material including the plate-type carbon material and a coating layer configured to coat at least a part of a surface of the plate-type carbon material, and stacking the anode active material layer including the anode active material on an anode current collector, wherein a length ratio (a/c) of a major axis (a) to a thickness (c) of the plate-type carbon material is 4 or more, and wherein the coating layer includes the lithiophilic material derived from the precursor.

In a preferred embodiment, the length ratio (a/c) of the major axis (a) to the thickness (c) of the plate-type carbon material may be 4.130 to 5.987.

In another preferred embodiment, an average orientation angle of the major axis (a) of the plate-type carbon material to a plane direction of the anode current collector may be 12° or less.

In still another preferred embodiment, the coating layer may be prepared using chemical vapor deposition.

In yet another preferred embodiment, the precursor may include a material selected from the group consisting of SiH₄, Si₂H₆, Si₃H₈, SiCl₄, SiHCl₃, Si₂Cl₆, SiH₂Cl₂, SiH₃Cl, and combinations thereof.

In still yet another preferred embodiment, a thickness of the coating layer may be 20 nm to 200 nm.

In a further preferred embodiment, the anode active material layer may further include an inorganic electrolyte. Here, a weight ratio of the anode active material to the inorganic electrolyte included in the anode active material layer may be 1:0.5 to 1:1.

Other aspects and preferred embodiments of the disclosure are discussed infra.

The above and other features of embodiments of the disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the embodiments of the present disclosure, and wherein:

FIG. 1 illustrates a cross-sectional view of an all-solid-state battery according to an embodiment of the present disclosure;

FIG. 2 illustrates a schematic perspective view of an anode active material according to an embodiment of the present disclosure;

FIG. 3 illustrates a schematic cross-sectional view of the anode active material according to an embodiment of the present disclosure;

FIG. 4 illustrates a cross-sectional view of an anode active layer including the anode active material according to an embodiment of the present disclosure;

FIG. 5 illustrates a plan view of the anode active layer including the anode active material and an inorganic electrolyte according to an embodiment of the present disclosure;

FIGS. 6A to 6D illustrate scanning electron microscope (SEM) images of different positions of the side surface of a plate-type carbon material used in a process of synthesizing an anode active material according to Manufacturing Example 1;

FIGS. 7A to 7D illustrate SEM images of different positions of the front surface of the plate-type carbon material used in the process of synthesizing the anode active material according to Manufacturing Example 1;

FIGS. 8A to 8D illustrate SEM images of different positions of a spherical carbon material used in a process of synthesizing an anode active material according to Comparative Manufacturing Example 1;

FIGS. 9A and 9B illustrate SEM images of the cross-section of an all-solid-state battery according to Example 1 taken at different magnifications;

FIGS. 10A and 10B illustrate SEM images of the cross-section of an all-solid-state battery according to Comparative Example 1 taken at different magnifications;

FIGS. 11A and 11B illustrate SEM images of the cross-section of an all-solid-state battery according to Comparative Example 2 taken at different magnifications;

FIG. 12 illustrates a graph representing orientation angles of the major axes of plate-type carbon materials to anode current collectors included in the all-solid-state batteries according to Example 1 and Comparative Example 2;

FIG. 13 illustrates an SEM image of the cross-section of the all-solid-state battery according to Example 1 in a fully discharged state after a charge and discharge cycle was performed 100 times;

FIG. 14 illustrates an SEM image of the cross-section of the all-solid-state battery according to Comparative Example 1 in the fully discharged state after the charge and discharge cycle was performed 100 times;

FIG. 15 illustrates a graph representing evaluation results of cell characteristics of the all-solid-state batteries according to Example 1 and Comparative Example 1 when a formation process was performed at a rate of 0.1 C;

FIG. 16 illustrates a graph representing evaluation results of the cell characteristics of the all-solid-state batteries according to Example 1 and Comparative Example 1 when the all-solid-state batteries were charged and discharged at a rate of 0.3 C after the formation process; and

FIG. 17 illustrates a graph representing evaluation results of capacity retentions of the all-solid-state batteries according to Example 1 and Comparative Example 1 while performing the charge and discharge cycle 100 times.

It should be understood that the appended drawings are not necessarily to scale, presenting a somewhat simplified representation of various preferred features illustrative of the basic principles of embodiments of the disclosure. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of embodiments of the present disclosure throughout the several figures of the drawings.

### DETAILED DESCRIPTION OF ILLUSTRATIVE EMBODIMENTS

The above-described objects, other objects, advantages, and features of embodiments of the present disclosure will become apparent from the descriptions of embodiments given hereinbelow with reference to the accompanying drawings. However, the embodiments of the present disclosure are not limited to the embodiments disclosed herein and may be implemented in various different forms. The embodiments are provided to make the description of the embodiments of the present disclosure thorough and to fully convey the scope of the embodiments of the present disclosure to those skilled in the art.

In the drawings, the same or similar elements are denoted by the same reference numerals even though they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the embodiments of the disclosure. Singular expressions may encompass plural expressions, unless they have clearly different contextual meanings.

In the following description of the embodiments, terms, such as “including”, “comprising”, and “having”, are to be interpreted as indicating the presence of characteristics, numbers, steps, operations, elements, or parts stated in the description or combinations thereof, and they do not exclude the presence of one or more other characteristics, numbers, steps, operations, elements, parts, or combinations thereof, or the possibility of adding the same. In addition, it will be understood that, when a part, such as a layer, a film, a region, or a plate, is said to be “on” another part, the part may be located “directly on” the other part or other parts may be interposed between the two parts. In the same manner, it will be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected and thus it will be understood that they are modified by the term “about”, unless stated otherwise. In addition, it will be understood that if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9, and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

### Anode for All-Solid-State Batteries and All-Solid-State Battery Including the Same

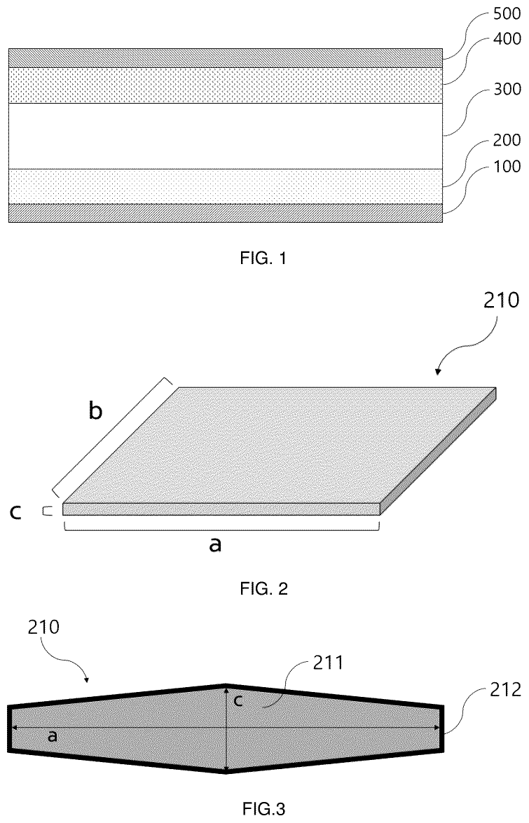

FIG. 1 shows an all-solid-state battery including an anode according to an embodiment of the present disclosure. Referring to FIG. 1, the all-solid-state battery may include an anode current collector 100, an anode active material layer 200 located on the anode current collector 100 and including an anode active material 210, a solid electrolyte layer 300 located on the anode active material layer 200 and including a solid electrolyte, a cathode active material layer 400 located on the solid electrolyte layer 300 and including a cathode active material, and a cathode current collector 500 located on the cathode active material layer 400.

The anode according to one embodiment of the present disclosure may include the anode current collector 100 and the anode active material layer 200 located on the anode current collector 100 and including the anode active material 210, and the anode active material 210 may include a plate-type carbon material 211 and a coating layer 212 configured to coat at least a part of a surface of the plate-type carbon material 211.

The anode current collector 100 may be a plate-type base having electrical conductivity. Concretely, the anode current collector 100 may be provided in the form of a sheet, a thin film, or foil.

The anode current collector 100 may include a material which does not react with lithium. Concretely, the anode current collector 100 may include a material selected from the group consisting of nickel (Ni), copper (Cu), stainless steel (SUS), and combinations thereof. The thickness of the anode current collector 100 may be, for example, 1 μm to 500 μm, without being limited to a specific value.

FIG. 2 is a schematic perspective view of the plate-type carbon material 211. Referring to FIG. 2, particles of the plate-type carbon material 211 may have a plate shape having an arbitrary major axis a, minor axis b, and a thickness c. Here, the major axis a and the minor axis b may indicate axes included in a direction parallel to a wide plane of the particle of the plate-type carbon material 211. Concretely, among two axes included in the wide plane of the particle of plate-type carbon material 211 and being perpendicular to each other, a long axis may be referred to as the major axis a, and a short axis may be referred to as the minor axis b.

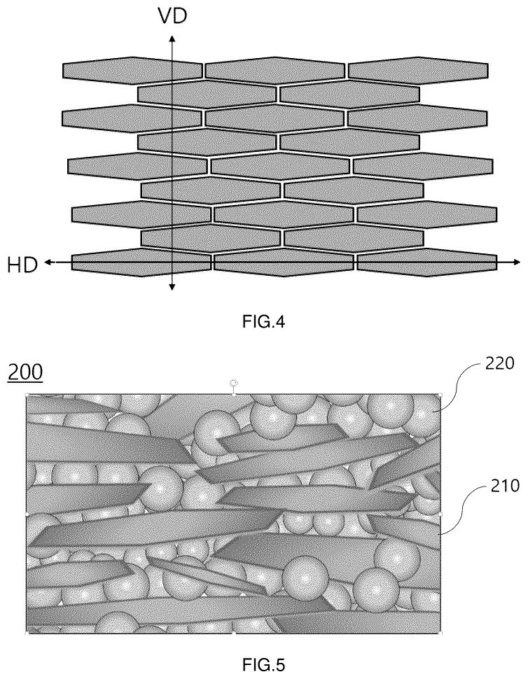

FIG. 3 is a schematic cross-sectional view of the anode active material 210 according to an embodiment of the present disclosure, and FIG. 4 is a cross-sectional view of the anode active material layer 200 including the anode active material 210 according to an embodiment of the present disclosure.

Referring to FIG. 3, the anode active material 210 may include the plate-type carbon material 211 and the coating layer 212 configured to coat at least a part of the surface of the plate-type carbon material 211, and the coating layer 212 may include a lithiophilic material.

A conventional anode active material including a spherical carbon material and a coating layer configured to coat at least a part of the surface of the spherical carbon material may be deformed by pressure applied during the assembly process of an all-solid-state battery using the anode active material or pressure due to volume expansion of the coating layer 212 in all directions during the charge and discharge process. Here, voids are formed among deformed conventional anode active material particles due to local volume expansion and contraction during the charge and discharge process, interfacial resistance is raised, and thus, electrochemical characteristics of the all-solid-state battery may be deteriorated.

The anode active material 210 according to an embodiment of the present disclosure includes the plate-type carbon material 211 and may distribute pressure applied to the anode active material 210 in a direction parallel to the plane of the plate-type carbon material 211 so as to minimize such deformation. Thereby, the all-solid-state battery including the anode active material 210 according to embodiments of the present disclosure suppresses local volume expansion and contraction during the charge and discharge process and may thus improve life characteristics of the all-solid-state battery and may minimize irreversible capacity reduction of the all-solid-state battery during initial charging and discharging.

Particularly, referring to FIG. 4, the anode active material 210 is present in the anode active material layer 200 in the state in which the particles of the plate-type carbon material 211 are stacked in the vertical direction VD. Here, an amount of the lithiophilic material per unit length included in the vertical direction VD in the anode active material layer 200 may be greater than an amount of the lithiophilic material per unit length included in the horizontal direction HD in the anode active material layer 200.

Thereby, while the volume of the conventional spherical carbon material expands in all directions during charging and discharging, volume expansion of the plate-type carbon material 211 is concentrated in the vertical direction VD, and thus, formation of voids in the anode active material layer 200 may be suppressed and contact between the anode active material 210 and the solid electrolyte or an inorganic electrolyte 220, which will be described below, may be improved.

In one embodiment, a length ratio (a/c) of the major axis a to the thickness c of the plate-type carbon material 211 may be 4 or more. Preferably, the length ratio (a/c) of the major axis a to the thickness c of the plate-type carbon material 211 may be 4.130 to 5.987 or more generally 4 to 6.

When the length ratio (a/c) of the major axis a to the thickness c of the plate-type carbon material 211 is less than 4.130, it may be difficult to achieve suppression of local volume expansion and contraction using the plate-type carbon material 211 according to embodiments of the present disclosure. Further, when the length ratio (a/c) of the major axis a to the thickness c of the plate-type carbon material 211 exceeds 5.987, the plate-type carbon material 211 is excessively thin and may thus be destroyed due to pressure during charging and discharging, and thereby, electrochemical characteristics of the all-solid-state battery may be reduced.

Further, a length ratio (a/b) of the major axis a to the minor axis b of the plate-type carbon material 211 may be 1.120 to 2.054 (about 1 to about 2). When the length ratio (a/b) of the major axis a to the minor axis b of the plate-type carbon material 211 exceeds 2.054, the length of the minor axis b and the thickness c are excessively short compared to the length of the major axis a, and thus, a needle-type carbon material rather than the plate-type carbon material 211 may be formed. In this case, it may be difficult to achieve an object of embodiments of the present disclosure, i.e., concentration of volume expansion in the vertical direction during charging and discharging.

In one embodiment, the plate-type carbon material 211 may include a material selected from the group consisting of natural graphite, artificial graphite, and a combination thereof.

In one embodiment, an average orientation angle of the major axis a of the plate-type carbon material 211 to the plane direction of the anode current collector 100 may be 12° or less. The lower limit of the average orientation angle may be, for example, 0° or more, without being limited to a specific value.

Here, the plane direction of the anode current collector 100 may indicate the horizontal direction of the anode current collector 100, as shown in FIG. 1. When the average orientation angle of the major axis a of the plate-type carbon material 211 to the plane direction of the anode current collector 100 exceeds 12°, it may be difficult to achieve an object of embodiments of the present disclosure, which is improvement in life characteristics and electrochemical characteristics of the all-solid-state battery due to concentration of volume expansion in the vertical direction during charging and discharging.

In one embodiment, the lithiophilic material may include a material selected from the group consisting of silicon (Si), silver (Ag), manganese (Mg), tin (Sn), bismuth (Bi), zinc (Zn), and combinations thereof. Preferably, the lithiophilic material may include amorphous silicon (Si). The lithiophilic material may indicate a material which may form an alloy with lithium (Li).

When a general all-solid-state battery is charged, lithium ions (Li⁺) may be discharged from a cathode active material and may reach an anode active material via a solid electrolyte layer having high lithium ion conductivity. The lithium ions (Li⁺) migrated to the anode active material may be inserted among particles of an anode active material, e.g., graphite, or may be deposited and stored in the form of lithium metal.

The anode according to embodiments of the present disclosure includes the lithiophilic material, which may form an alloy with lithium, on the surface of the plate-type carbon material 211, and thus, when the all-solid-state battery is charged, the lithium ions may be stored in the form of an alloy on the surface of the coating layer 212.

In one embodiment, the thickness of the coating layer 212 may be 20 nm to 200 nm. When the thickness of the coating layer 212 is less than 20 nm, the content of the lithiophilic material included in the coating layer 212 is excessive small, and thus, capacity characteristics of the all-solid-state battery may be deteriorated. When the thickness of the coating layer 212 exceeds 200 nm, volume expansion of the all-solid-state battery may become severe.

In one embodiment, the anode active material 210 may include 10 wt % to 60 wt % of the coating layer 212 with respect to the total weight of the anode active material 210. When the amount of the coating layer 212 is less than 10 wt % with respect to the total weight of the anode active material 210, the amount of the lithiophilic material included in the coating layer 212 is excessive small, and thus, capacity characteristics of the all-solid-state battery may be deteriorated. When the amount of the coating layer 212 exceeds 60 wt % with respect to the total weight of the anode active material 210, volume expansion of the all-solid-state battery may become severe.

In one embodiment, the anode active material layer 200 may include the inorganic electrolyte 220. FIG. 5 is a plan view of the anode active material layer 200 including the anode active material 210 and the inorganic electrolyte 220 according to an embodiment of the present disclosure. Referring to FIG. 5, the inorganic electrolyte 220 may fill spaces among particles of the anode active material 210 so as to improve lithium ion conductivity in the anode active material layer 200. Thereby, formation of a lithium alloy on the surface of the coating layer 212 during charging and discharging of the all-solid-state battery may become easier.

Concretely, the inorganic electrolyte 220 may employ a solid electrolyte having lithium ion conductivity. The inorganic electrolyte 220 may include an oxide-based inorganic electrolyte, a sulfide-based inorganic electrolyte, and the like. Preferably, a sulfide-based inorganic electrolyte having high lithium ion conductivity may be used. The sulfide-based inorganic electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₃-LiI, Li₂S-B₂S₃, Li₂S-P₂S₅-ZₘSₙ (m and n being positive numbers, and Z being one of Ge, Zn, and Ga), Li₂S-GeS₂, Li₂S-SiS₂-Li₃PO₄, Li₂S-SiS₂-LiₓMO_{y} (x and y being positive numbers, and M being one of P, Si, Ge, B, Al, Ga, and In), Li₁₀GeP₂S₁₂, or the like, without being limited to a specific material.

The oxide-based inorganic electrolyte may include perovskite-type LLTO (Li₃ₓLa_{2/3}-ₓTiO₃), phosphate-based NASICON-type LATP (Li₁₊ₓAlₓTi₂₋ₓ(PO₄)₃), or the like. The inorganic electrolyte may be the same as or different from the solid electrolyte included in the solid electrolyte layer 300, which will be described below.

In addition, the anode active material layer 200 may further include a conductive material, a binder, and the like. The conductive material may be carbon black, conductive graphite, ethylene black, vapor grown carbon fibers, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

The solid electrolyte layer 300 may be located between the cathode active material layer 400 and the anode active material layer 200 and may include the solid electrolyte having lithium ion conductivity.

The solid electrolyte may include an oxide-based solid electrolyte, a sulfide-based solid electrolyte, and the like. Preferably, a sulfide-based solid electrolyte having high lithium ion conductivity may be used.

The sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (m and n being positive numbers, and Z being one of Ge, Zn, and Ga), Li₂S-GeS₂, Li₂S-SiS₂-Li₃PO₄, Li₂S-SiS₂-LiₓMO_{y} (x and y being positive numbers, and M being one of P, Si, Ge, B, Al, Ga, and In), Li₁₀GeP₂S₁₂, or the like, without being limited to a specific material. The oxide-based solid electrolyte may include perovskite-type LLTO (Li₃ₓLa_{2/3}-ₓTiO₃), phosphate-based NASICON-type LATP (Li₁₊ₓAlₓTi₂₋ₓ(PO₄)₃), or the like.

The solid electrolyte included in the solid electrolyte layer 300 may be the same as or different from the inorganic electrolyte 220 included in the anode active material layer 200.

The cathode active material layer 400 may include a cathode active material, a solid electrolyte, a conductive material, a binder, and the like. The cathode active material may intercalate and deintercalate lithium ions thereinto and therefrom and may include a rocksalt layer-type active material, such as LiCoO₂, LiMnO₂, LiNiO₂, LiVO₂, or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄, or LiNiPO₄, a silicon-containing active material, such as Li₂FeSiO₄ or Li₂MnSiO₄, a rocksalt layer-type active material in which a part of a transition metal is substituted with a different kind of metal, such as LiNi_{0.8}Co_{(0.2-x})AlₓO₂(0<x<0.2), a spinel-type active material in which a part of a transition metal is substituted with a different kind of metal, such as Li₁₊ₓMn_{2-x-y}MyO₄ (M being one of Al, Mg, Co, Fe, Ni, or Zn, and 0<x+y<2), lithium titanate, such as Li₄Ti₅O₁₂, or the like.

The solid electrolyte, the conductive material, and the binder included in the cathode active material layer 400 are substantially the same as the above-described solid electrolyte, conductive material, and binder, and a detailed description thereof will thus be omitted.

The cathode current collector 500 may be a plate-type base having electrical conductivity. For example, the cathode current collector 500 may include aluminum foil. Here, the thickness of the cathode current collector 500 may be, for example, 1 μm to 500 μm, without being limited to a specific value.

Volume expansivity of the all-solid-state battery according to embodiments of the present disclosure may be less than that of the all-solid-state battery using the conventional spherical carbon material which realizes the same discharge capacity. In one embodiment, the all-solid-state battery according to embodiments of the present disclosure satisfies the Equation below.

$$( {V}_{100} - {V}_{0} ) / {V}_{0} \times 100 \leq 12 \% \qquad Equation$$

In the Equation, V₁₀₀ is the volume of the anode active material layer 200 in a fully discharged state of the all-solid-state battery after a charge and discharge cycle was performed 100 times, and V₀ is the volume of the anode active material layer 200 when charging and discharging of the all-solid-state battery is not performed.

The above Equation may indicate the volume expansivity of the all-solid-state battery. Here, when (V₁₀₀−V₀)/V₀×100 exceeds 12%, lithium dendrites may be irreversibly formed in the anode active material layer 200 or a large number of voids may be formed among the particles of the anode active material 210, and thus, electrochemical characteristics of the all-solid-state battery may be deteriorated.

### Manufacturing Method of Anode for All-Solid-State Batteries

According to another embodiment of the present disclosure, there may be provided a manufacturing method of the anode for all-solid-state batteries including preparing the plate-type carbon material 211 and a precursor of the lithiophilic material, synthesizing the anode active material 210 including the plate-type carbon material 211 and the coating layer 212 provided to coat at least a part of the surface of the plate-type carbon material 211, and stacking the anode active material layer 200 including the anode active material 210 on the anode current collector 100, wherein the length ratio (a/c) of the major axis a to the thickness c of the plate-type carbon material 211 may be 4 or more, and wherein the coating layer 212 may include the lithiophilic material derived from the precursor.

In one embodiment, the coating layer 212 may be prepared using chemical vapor deposition. Chemical vapor deposition is a process of depositing a solid material on the surface of an arbitrary base material by converting the solid material into a gaseous phase, and a chemical vapor deposition method, which is generally used, may be used to deposit a lithiophilic material, for example, silicon (Si), on the surface of a carbon material.

When the coating layer 212 is prepared using chemical vapor deposition, the precursor may be gas-phase molecules including the lithiophilic material. For example, the precursor may include a material selected from the group consisting of SiH₄, Si₂H₆, Si₃H₈, SiCl₄, SiHCl₃, Si₂Cl₆, SiH₂Cl₂, SiH₃Cl, and combinations thereof.

In one embodiment, the length ratio (a/c) of the major axis a to the thickness c of the plate-type carbon material 211 may be 4.130 to 5.987 or more generally 4 to 6.

In one embodiment, the average orientation angle of the major axis a of the plate-type carbon material 211 to the plane direction of the anode current collector 100 may be 12° or less.

In one embodiment, the thickness of the coating layer 212 may be 20 nm to 200 nm.

In one embodiment, the anode active material layer 200 may include the inorganic electrolyte 220. Here, a weight ratio of the anode active material 210 to the inorganic electrolyte 220 included in the anode active material layer 200 may be 1:0.5 to 1:1. When the weight ratio of the anode active material 210 to the inorganic electrolyte 220 is less than 1:0.5, the amount of the inorganic electrolyte 220 is excessively small, and thus, lithium ion conductivity of the anode active material layer 200 may be reduced, and delamination between the anode active material 210 and the inorganic electrolyte 220 may occur. When the weight ratio of the anode active material 210 to the inorganic electrolyte 220 exceeds 1:1, the amount of the inorganic electrolyte 220 is excessively large, and thus, the energy density of the all-solid-state battery may be reduced.

The anode manufactured through the manufacturing method is substantially the same as the above-described anode for all-solid-state batteries, and a redundant description thereof will thus be omitted.

Hereinafter, embodiments of the present disclosure will be described in more detail through the following Examples and Comparative Examples. The following Examples and Comparative Examples serve merely to exemplarily describe embodiments of the present disclosure and are not intended to limit the scope and spirit of the embodiments of the disclosure.

### Manufacturing Example 1—Plate-type Carbon Material and Si Coating Layer

(a) A plate-type carbon material 211 configured such that a length ratio (a/c) of a major axis a to a thickness thereof is controlled to a designated range and silane (SiH₄) gas serving as a precursor of a lithiophilic material were prepared.
(b) The plate-type carbon material 211 was put into a vacuum reactor used in chemical vapor deposition (CVD), and the vacuum reactor was put into a vacuum. The surface of the plate-type carbon material 211 was coated with a coating layer 212 including the lithiophilic material for 30 minutes by supplying the prepared silane (SiH₄) gas to the inside of the vacuum reactor, after heating the vacuum reactor to a temperature of 1,100° C. An anode active material 210 according to Manufacturing Example 1 was synthesized through the above process.

### Comparative Manufacturing Example 1—Spherical Carbon Material and Si Coating Layer

An anode active material 210 was synthesized through the same process as in Manufacturing Example 1, except that a spherical carbon material other than the plate-type carbon material 211 configured such that the length ratio (a/c) of the major axis a to the thickness thereof is controlled to the designated range was used.

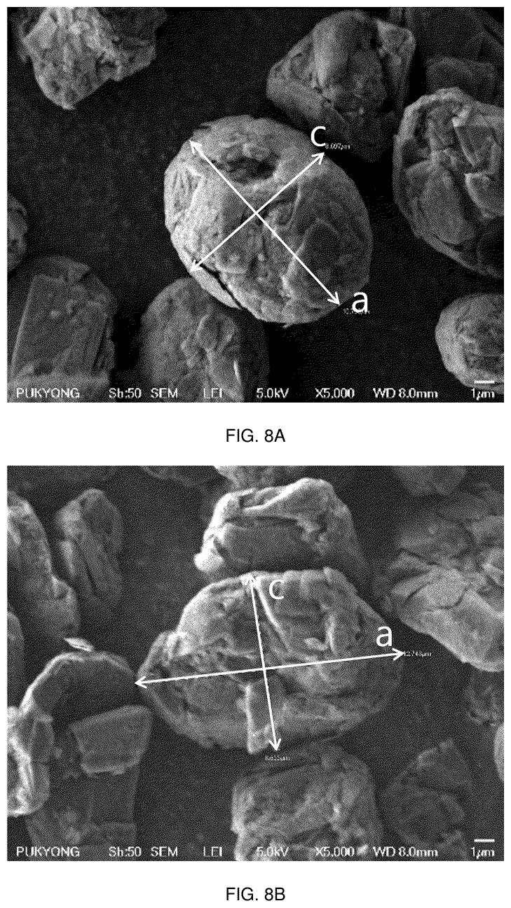

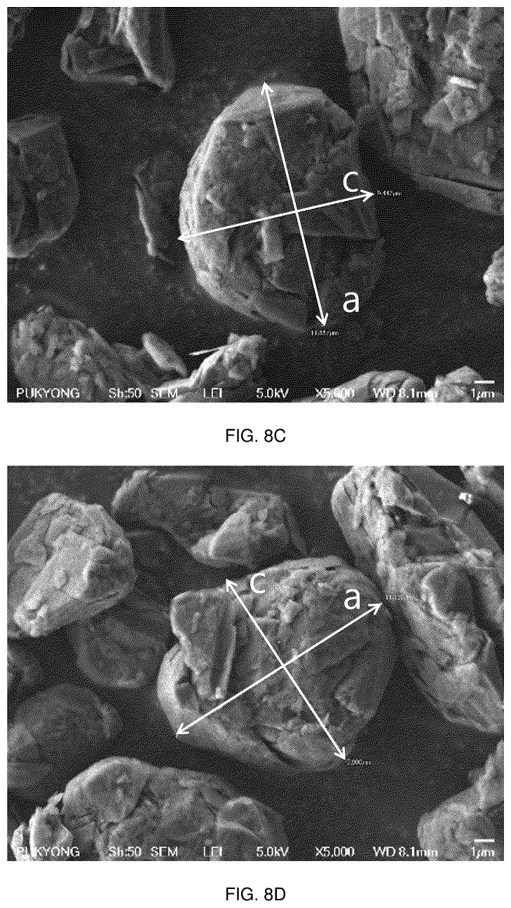

In order to confirm the length ratio (a/c) of the major axis a to the thickness of the spherical carbon material, scanning electron microscope (SEM) images of the spherical carbon material were obtained, as shown in FIGS. 8A to 8D.

### Comparative Manufacturing Example 2—Plate-type Carbon Material

The same plate-type carbon material as in Manufacturing Example 1 was prepared as an anode active material.

### Test Example 1—Measurement of Length Ratios (a/c) of Major Axes a to Thicknesses c of Carbon Materials

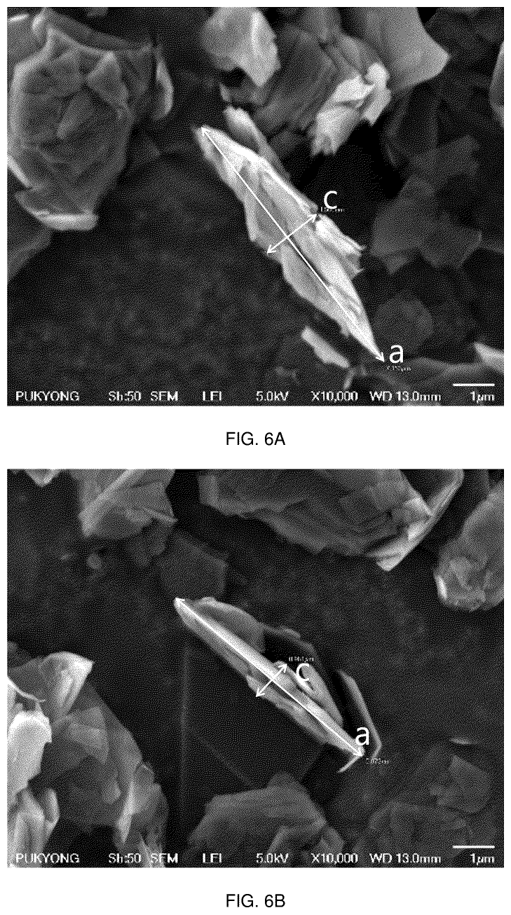

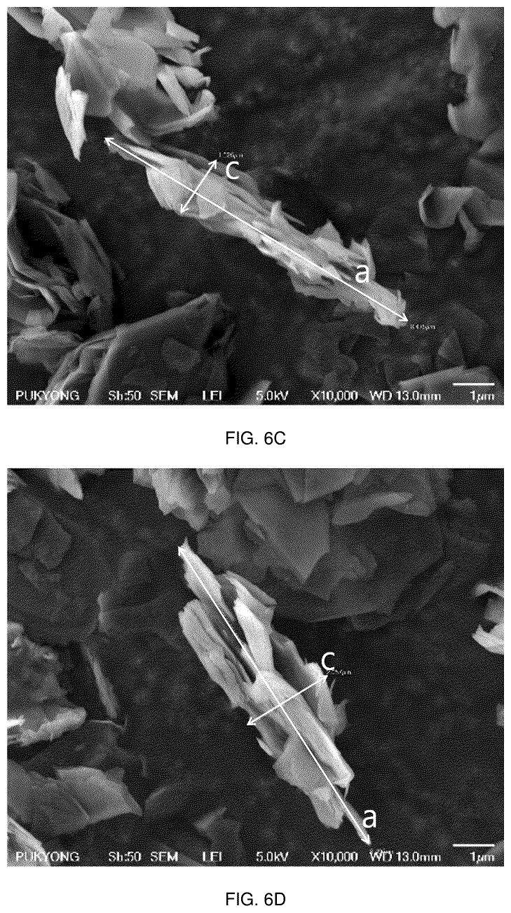

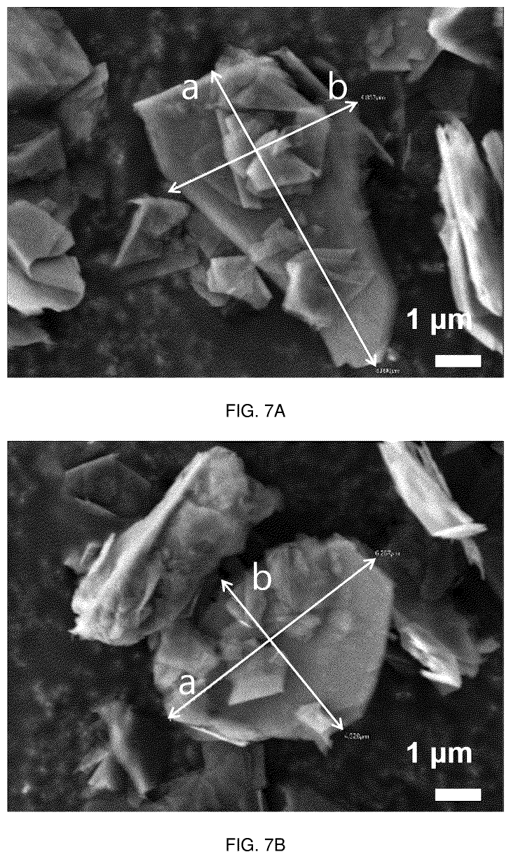

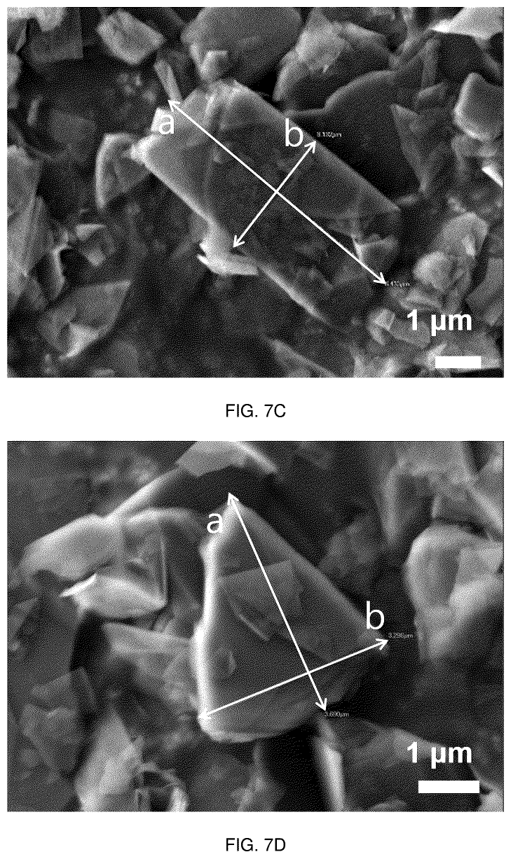

In order to confirms the length ratios (a/c) of the major axes a to the thicknesses c of the prepared carbon materials, the side and front surfaces of the plate-type carbon material 211 prepared in step (a) of Manufacturing Example 1 were taken four times each with a scanning electron microscope (SEM) by varying measurement positions of the side and front surfaces of the plate-type carbon material 211. FIGS. 6A to 6D are SEM images of different positions of the side surface of the plate-type carbon material 211, and FIGS. 7A to 7D are SEM images of different positions of the front surface of the plate-type carbon material 211.

Further, the spherical carbon material was taken four times with the scanning electron microscope (SEM) by varying a measurement position of the spherical carbon material, and FIGS. 8A to 8D are SEM images of different positions of the spherical carbon material.

The lengths of the major axes a and the thicknesses c of the respective positions of the plate-type carbon material 211, and the length ratios (a/c) thereof observed from FIGS. 6A to 6D and lengths of the major axes a and the thicknesses c of the respective positions of the spherical carbon material, and the length ratios (a/c) thereof observed from FIGS. 8A to 8D are set forth in Table 1 below. In the spherical carbon material, among two different axes being perpendicular to each other, a long axis was defined as the major axis a, and a short axis was defined as the thickness c.

TABLE 1

| | Major axis | Thickness | Ratio of major axis | |
|---|---|---|---|---|
| Category | (a) μm | (c) μm | to thickness (a/c) | |
| Manufacturing | 7.153 | 1.506 | 4.750 | 4.130 ≤ a/ |
| example 1 | 5.873 | 0.981 | 5.987 | c ≤ 5.987 |
| | 8.475 | 1.526 | 5.554 | |
| | 8.496 | 2.057 | 4.130 | |
| Comparative | 10.790 | 8.697 | 1.241 | 1.189 ≤ a/ |
| manufacturing | 12.743 | 8.655 | 1.472 | c ≤ 1.472 |
| example 1 | 11.887 | 9.447 | 1.258 | |
| | 11.863 | 9.980 | 1.189 | |

As set forth in Table 1, it is confirmed that the length ratio (a/c) of the major axis a to the thickness c of the plate-type carbon material 211 according to embodiments of the present disclosure is in a numerical range of 4.130 to 5.987 or more generally 4 to 6.

Further, the lengths of the major axes a and the lengths of the minor axes b of the respective positions of the plate-type carbon material 211, and the length ratios (a/b) thereof observed from FIGS. 7A to 7D are set forth in Table 2 below. Here, among the two different axes being perpendicular to each other, a long axis was defined as the major axis a, and a short axis was defined as the minor axis b.

TABLE 2

| | Major axis | Minor axis | Ratio of major axis to |
|---|---|---|---|
| Category | (a) μm | (b) μm | minor axis (a/b) |
| Manufacturing | 8.090 | 4.853 | 1.667 |
| example 1 | 6.267 | 4.528 | 1.384 |
| | 6.433 | 3.132 | 2.054 |
| | 3.690 | 3.296 | 1.120 |
| Range | 3.690 ≤ a ≤ | 3.132 ≤ b ≤ | 1.120 ≤ a/ |
| | 8.090 | 4.853 | b ≤ 2.054 |

As set forth in Table 2, it is confirmed that the length ratio (a/b) of the major axis a to the minor axis b of the plate-type carbon material 211 according to embodiments of the present disclosure is in a numerical range of 1.120 to 2.054.

### Example 1

(a) The anode active material 210 according to Manufacturing Example 1, Li₆PS₅Cl, which is a sulfide-based inorganic electrolyte 220 having an argyrodite-type crystal structure, butadiene rubber as a binder, and vapor grown carbon fibers (VGCFs) as a conductive material were prepared at a weight ratio of 58:39:2:1.
(b) An anode active material slurry was prepared by putting the anode active material 210, the inorganic electrolyte 220, the binder, and the conductive material into hexyl butyrate serving as a solvent and mixing the same. Here, the weight ratio of hexyl butyrate to the anode active material 210, the inorganic electrolyte 220, the binder, and the conductive material prepared in step (a) was 6.3:93.7.
(c) An anode in which the anode active material layer 200 is stacked on an anode current collector 100 was acquired by applying the anode active material slurry to a nickel (Ni) thin film serving as the anode current collector 100 and then drying the slurry at a temperature of 80° C. in an argon (Ar) atmosphere for 10 minutes and at a temperature of 100° C. in a vacuum for 2 hours or more within an oven.
(d) An all-solid-state battery cell was manufactured by sequentially stacking the anode, a solid electrolyte layer 300 including Li₆PS₅Cl as a sulfide-based inorganic electrolyte having an argyrodite-type crystal structure, and a lithium (Li) thin film and then pressing the same. Here, the discharge capacity of the manufactured all-solid-state battery cell was set to about 1,000 mAh/g.

### Comparative Example 1

An all-solid-state battery cell according to Comparative Example 1 was manufactured through the same process as in Example 1 except that the anode active material 210 according to Comparative Manufacturing Example 1 was used. Here, the discharge capacity of the manufactured all-solid-state battery cell was set to about 1,000 mAh/g.

### Comparative Example 2

(a) The anode active material 210 according to Comparative Manufacturing Example 2, butadiene rubber as a binder, and vapor grown carbon fibers (VGCFs) as a conductive material were prepared at a weight ratio of 58:2:1.
(b) An anode active material slurry was prepared by putting the anode active material 210, the binder, and the conductive material into hexyl butyrate serving as a solvent and mixing the same. Here, the weight ratio of hexyl butyrate to the anode active material 210, the binder, and the conductive material prepared in step (a) was 6.3:93.7.
(c) An anode in which the anode active material layer 200 is stacked on an anode current collector 100 was acquired by applying the anode active material slurry to a nickel (Ni) thin film serving as the anode current collector 100 and then drying the slurry at a temperature of 80° C. in an argon (Ar) atmosphere for 10 minutes and at a temperature of 100° C. in a vacuum for 2 hours or more within an oven.
(d) An all-solid-state battery cell according to Comparative Example 2 was manufactured by sequentially stacking the anode, a solid electrolyte layer 300 including Li₆PS₅Cl as a sulfide-based inorganic electrolyte having an argyrodite-type crystal structure, and a lithium (Li) thin film and then pressing the same.

### Test Example 2—Structural Characteristics of All-Solid-State Batteries

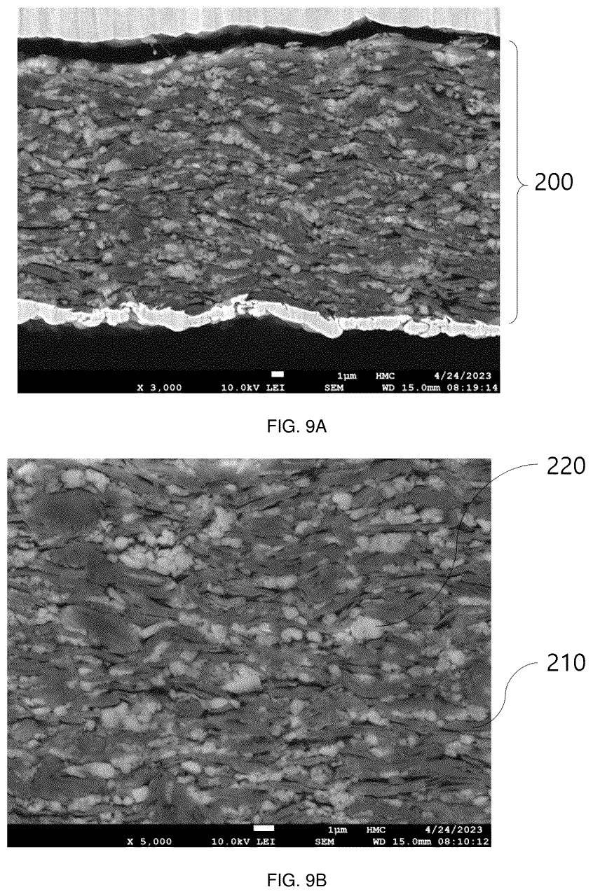

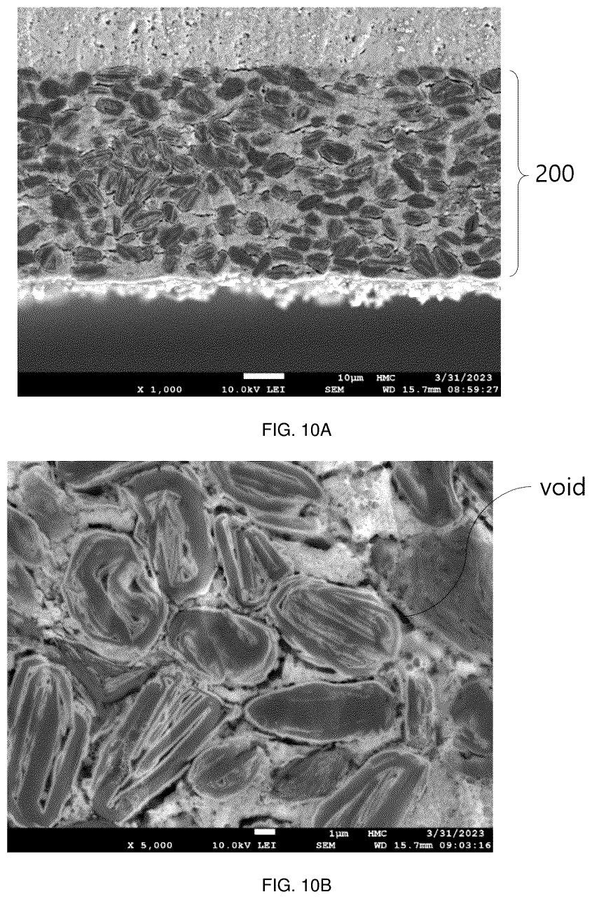

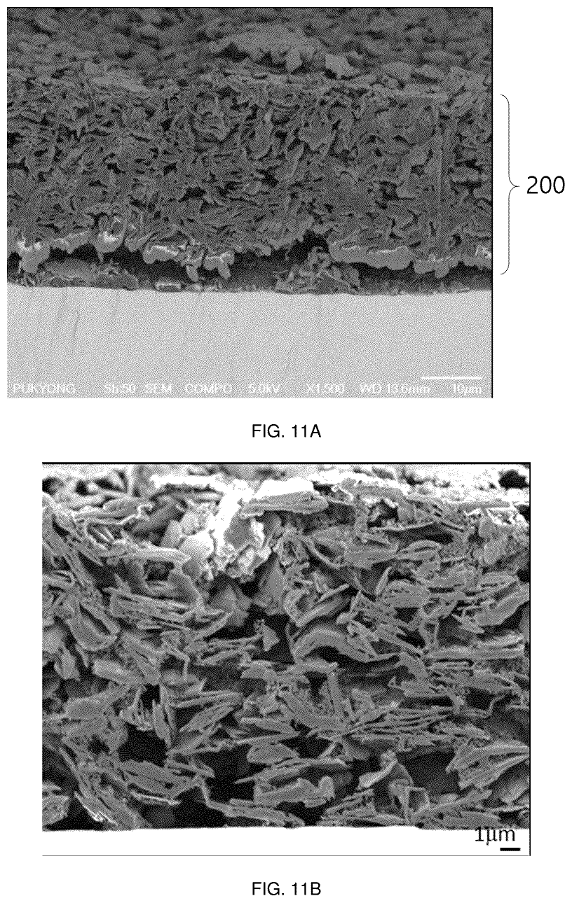

FIGS. 9A and 9B are SEM images of the cross-section of the all-solid-state battery according to Example 1 taken at different magnifications, and FIGS. 10A and 10B are SEM images of the cross-section of the all-solid-state battery according to Comparative Example 1 taken at different magnifications. FIGS. 11A and 11B are SEM images of the cross-section of the all-solid-state battery according to Comparative Example 2 taken at different magnifications.

Referring to FIGS. 9A and 9B, it may be confirmed that the anode active material layer 200 of the all-solid-state battery according to Example 1 includes the anode active material 210, including the plate-type carbon material 211 having plate-type carbon particles arranged parallel to the plane direction of the anode current collector 100, and the inorganic electrolyte 220 configured to fill spaces among particles of the anode active material 210.

Referring to FIGS. 10A and 10B, it may be confirmed that the anode active material layer 200 of the all-solid-state battery according to Comparative Example 1 includes the anode active material 210, including the spherical carbon material having spherical carbon particles arranged randomly in the plane direction of the anode current collector 100, and the inorganic electrolyte 220 configured to fill spaces among particles of the anode active material 210.

Referring to FIGS. 11A and 11B, it may be confirmed that the anode active material layer 200 of the all-solid-state battery according to Comparative Example 2 includes the plate-type carbon material 211 having plate-type carbon particles arranged parallel to the plane direction of the anode current collector 100 and arranged somewhat randomly compared to Example 1. Further, it may be confirmed that the anode active material layer 200 includes a large number of voids formed among particles of the plate-type carbon material 211.

### Test Example 3—Orientation Angles of Plate-type Carbon Materials to Anode Current Collectors

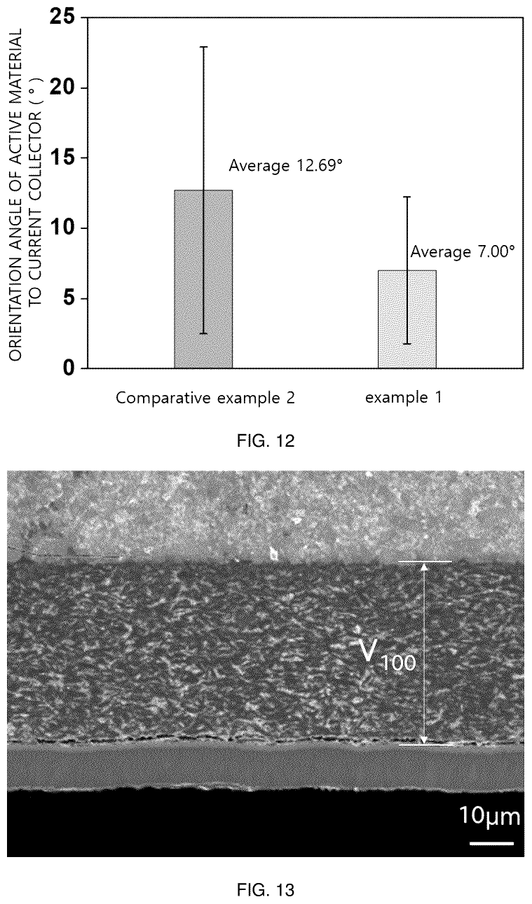

FIG. 12 is a graph representing orientation angles of the major axes of the plate-type carbon materials 211 to the anode current collectors 100 included in the all-solid-state batteries according to Example 1 and Comparative Example 2. Concretely, the orientation angles of the major axes a of the plate-type carbon materials 211 to the anode current collectors 100 observed from FIGS. 9B and 11B were measured, and averages thereof were calculated.

The average orientation angle of the major axis a of the plate-type carbon material 211 to the anode current collector 100 confirmed from Example 1 was 7.00°, and it is confirmed that a deviation from the average orientation angle is in the range of −4.86° to +5.58° (i.e., −4.86°≤x₁≤+5.58°). Further, the average orientation angle of the major axis a of the plate-type carbon material 211 to the anode current collector 100 confirmed from Comparative Example 2 was 12.69°, and it is confirmed that a deviation from the average orientation angle is in the range of −10.03° to +10.39° (i.e., −10.03°≤x₂≤+10.39°)

As described above, it is confirmed that the average orientation angle of the major axis a of the plate-type carbon material 211 to the anode current collector 100 included in the all-solid-state battery according to Example 1 is lower than the average orientation angle of the major axis a of the plate-type carbon material 211 to the anode current collector 100 included in the all-solid-state battery according to Comparative Example 2. That is to say, the plate-type carbon material 211 was arranged more parallel to the plane direction of the anode current collector 100 in the all-solid-state battery according to Example 1 than in the all-solid-state battery according to Comparative Example 2.

It is predicted that these results are caused by more regular arrangement of the anode active material 210 in the evaporation process of the solvent included in the anode active material slurry, as the particle strength of the anode active material 210 increases due to coating of the surface of the plate-type carbon material 211 with the lithiophilic material, for example silicon (Si).

### Test Example 4—Volume Expansivities of Anode Active Material Layers

The following test was performed to confirm the volume expansivities of the anode active material layers 200.

First, the thicknesses of the anodes of the all-solid-state batteries according to Example 1 and Comparative Example 1, in which the charge and discharge cycle is not performed, were measured by a micrometer (293-240-30 manufactured by Mitutoyo), and the thickness V₀ of the anode current collector formed of nickel, i.e., 13 μm, was subtracted therefrom.

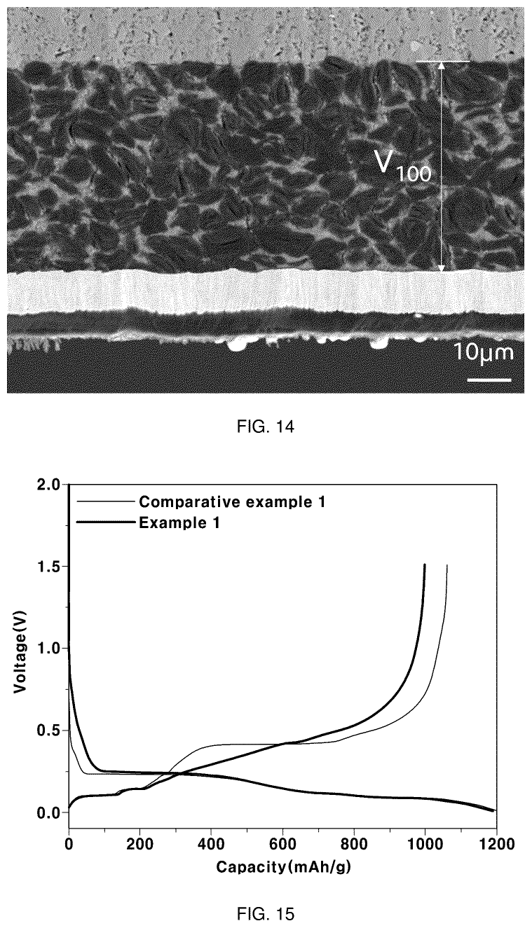

Thereafter, the cross-section of the all-solid-state battery according to Example 1 in the fully discharged state after the charge and discharge cycle was performed 100 times was taken with a field emission scanning electron microscope (JSM-7401F manufactured by JEOL), and an obtained SEM image is shown in FIG. 13, and the cross-section of the all-solid-state battery according to Comparative Example 1 in the fully discharged state after the charge and discharge cycle was performed 100 times was taken with the field emission scanning electron microscope, and an obtained SEM image is shown in FIG. 14.

The thicknesses V₁₀₀ of the anodes detected from FIGS. 13 and 14 were measured. Volume expansivities [(V₁₀₀−V₀)/V₀×100] obtained from the above test were calculated and are set forth in Table 3 below.

TABLE 3

| | | | Volume |
|---|---|---|---|
| Category | V₀ (μm) | V₁₀₀ (μm) | expansivity (%) |
| Example 1 | 39 | 40.1 | 2.8 |
| Comparative Example 1 | 41 | 46.1 | 12.4 |

As set forth in Table 3, it is confirmed that the volume expansivity of the anode of the all-solid-state battery using the plate-type carbon material 211 according to Example 1 is much lower than the volume expansivity of the anode of the all-solid-state battery using the spherical carbon material according to Comparative Example 1.

### Test Example 5—Electrochemical Characteristics of All-Solid-State Batteries

FIG. 15 is a graph representing evaluation results of cell characteristics of the all-solid-state batteries according to Example 1 and Comparative Example 1 when a formation process was performed at a rate of 0.1 C. Here, charging and discharging of the all-solid-state batteries were performed in a cut-off voltage range of 0.005 V to 1.5 V.

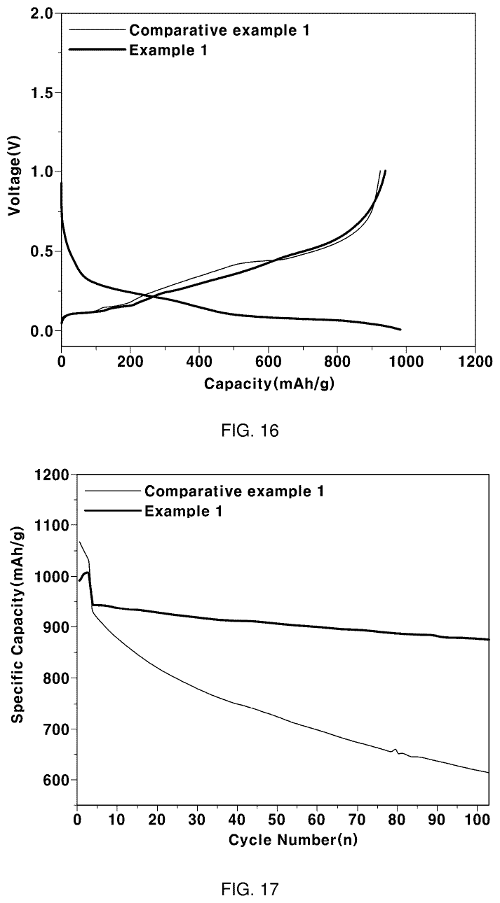

Further, FIG. 16 is a graph representing evaluation results of cell characteristics of the all-solid-state batteries according to Example 1 and Comparative Example 1 when charging and discharging of the all-solid-state batteries were performed at a rate of 0.3 C after the formation process. Here, charging and discharging of the all-solid-state batteries were performed in a cut-off voltage range of 0.005 V to 1.0 V.

In addition, in order to check life characteristics of the all-solid-state batteries, capacity retentions of the all-solid-state batteries according to Example 1 and Comparative Example 1 were evaluated while performing the charge and discharge cycle 100 times, and the evaluation results thereof are shown in FIG. 17.

Results of electrochemical characteristics of the all-solid-state batteries confirmed from FIGS. 15 to 17 are set forth in Table 4 below.

TABLE 4

| | | Discharge | Discharge | Capacity |
|---|---|---|---|---|
| | | capacity | capacity rate of | retention (%, |
| Category | C-rate | (mAh/g) | 0.3 C/0.1 C (%) | 100 cycles) |
| Example 1 | 0.1 C | 994 | 94.8 | 92.7 |
| | 0.3 C | 942 | | |
| Comparative | 0.1 C | 1063 | 87.2 | 66.2 |
| example 1 | 0.3 C | 927 | | |

As set forth in Table 4, it is confirmed that irreversible capacity reduction and life characteristics of the all-solid-state battery according to Example 1 are improved compared to the all-solid-state battery according to Comparative Example 1.

As is apparent from the above description, an anode according to embodiments of the present disclosure includes a plate-type carbon material, configured such that a length ratio (a/c) of a major axis a to a thickness thereof is controlled to a designated range, and a coating layer configured to coat at least a part of the surface of the plate-type carbon material, thereby being capable of minimizing the volume expansivity of an all-solid-state battery including the anode and improving life characteristics of the all-solid-state battery.

Embodiments of the disclosure have been described in detail with reference to preferred embodiments thereof. However, it will be appreciated by those skilled in the art that changes may be made in these embodiments without departing from the principles and spirit of the embodiments of the disclosure, the scope of which is defined in the appended claims and their equivalents.

What is claimed is:

1. An anode for an all-solid-state battery, the anode comprising:
an anode current collector; and
an anode active material layer disposed on the anode current collector and comprising an anode active material, the anode active material comprising:
a plate-type carbon material, wherein a length ratio (a/c) of a length (a) of a major axis to a thickness (c) of the plate-type carbon material is 4 or more; and
a coating layer coating a portion of a surface of the plate-type carbon material, wherein the coating layer comprises a lithiophilic material.

2. The anode of claim 1, wherein the plate-type carbon material comprises a material selected from the group consisting of natural graphite, artificial graphite, and a combination thereof.

3. The anode of claim 1, wherein the length ratio (a/c) of the length of the major axis (a) to the thickness (c) of the plate-type carbon material is 4.130 to 5.987.

4. The anode of claim 1, wherein a length ratio (a/b) of the major axis (a) to a minor axis (b) of the plate-type carbon material is 1.120 to 2.054.

5. The anode of claim 1, wherein an average orientation angle of the major axis of the plate-type carbon material to a plane direction of the anode current collector is 12° or less.

6. The anode of claim 1, wherein the lithiophilic material comprises a material selected from the group consisting of silicon (Si), silver (Ag), manganese (Mg), tin (Sn), bismuth (Bi), zinc (Zn), and combinations thereof.

7. The anode of claim 1, wherein the lithiophilic material comprises amorphous silicon (Si).

8. The anode of claim 1, wherein a thickness of the coating layer is 20 nm to 200 nm.

9. The anode of claim 1, wherein the anode active material comprises 10 wt % to 60 wt % of the coating layer with respect to a total weight of the anode active material.

10. The anode of claim 1, wherein the anode active material layer further comprises an inorganic electrolyte.

11. An all-solid-state battery comprising:
an anode comprising an anode current collector and an anode active material layer disposed on the anode current collector and comprising an anode active material, the anode active material comprising:
a plate-type carbon material, wherein a length ratio (a/c) of a length of a major axis (a) to a thickness (c) of the plate-type carbon material is 4 or more; and
a coating layer coating a portion of a surface of the plate-type carbon material, wherein the coating layer comprises a lithiophilic material;
a solid electrolyte layer disposed on the anode active material layer and comprising a solid electrolyte;
a cathode active material layer disposed on the solid electrolyte layer and comprising a cathode active material; and
a cathode current collector disposed on the cathode active material layer.

12. The all-solid-state battery of claim 11, configured to satisfy (V₁₀₀−V₀)/V₀×100≤12%, wherein V₁₀₀ is a volume of the anode active material layer in a fully discharged state of the all-solid-state battery after a charge and discharge cycle is performed 100 times, and V₀ is the volume of the anode active material layer in a state in which charging and discharging of the all-solid-state battery is not performed.

13. A manufacturing method of an anode for an all-solid-state battery, the method comprising:
preparing a plate-type carbon material and a precursor of a lithiophilic material;
synthesizing an anode active material, the anode active material comprising:
the plate-type carbon material, wherein a length ratio (a/c) of a length (a) of a major axis to a thickness (c) of the plate-type carbon material is 4 or more; and
a coating layer coating a portion of a surface of the plate-type carbon material, the coating layer comprising the lithiophilic material derived from the precursor; and
stacking an anode active material layer comprising the anode active material on an anode current collector.

14. The method of claim 13, wherein the length ratio (a/c) of the length (a) of the major axis to the thickness (c) of the plate-type carbon material is 4.130 to 5.987.

15. The method of claim 13, wherein an average orientation angle of the major axis of the plate-type carbon material to a plane direction of the anode current collector is 12° or less.

16. The method of claim 13, wherein the coating layer is prepared using chemical vapor deposition.

17. The method of claim 13, wherein the precursor comprises a material selected from the group consisting of SiH₄, Si₂H₆, Si₃H₈, SiCl₄, SiHCl₃, Si₂Cl₆, SiH₂Cl₂, SiH₃Cl, and combinations thereof.

18. The method of claim 13, wherein a thickness of the coating layer is 20 nm to 200 nm.

19. The method of claim 13, wherein the anode active material layer further comprises an inorganic electrolyte.

20. The method of claim 19, wherein a weight ratio of the anode active material to the inorganic electrolyte comprised in the anode active material layer is 1:0.5 to 1:1.
